(19) United States
(12) Patent Application Publication
(10) Pub. No.: US 2025/0060456 A1
(43) Pub. Date: Feb. 20, 2025

(54) LIDAR DEVICE USING CHANNEL GROUPING TO INCREASE ANGULAR RESOLUTION AND DETECTION RANGE

(71) Applicant: Liturex (Guangzhou) Co. Ltd, Guangzhou (CN)

(72) Inventor: XIMING REN, San Ramon, CA (US)

(21) Appl. No.: 18/235,490

(22) Filed: Aug. 18, 2023

(51) Int. Cl. G01S 7/481; G01S 7/48; G01S 7/4863

(52) U.S. Cl. CPC G01S 7/4813; G01S 7/4802; G01S 7/4808; G01S 7/4817; G01S 7/4863

(57) ABSTRACT

A LiDAR device with detector channel grouping is described in this disclosure. The LiDAR device can include a laser pulse scanner configured to scan laser pulses in a plurality of directions; a detector array that includes a plurality of adjacent detector channels; and a controlling unit configured to activate a group of adjacent detector channels of the plurality of adjacent detector channels corresponding to each of the plurality of directions based on one or more of an image width on the detector array corresponding to that direction after a laser pulse hits a target object, a measured ambient intensity from that direction, a reflectivity of the target object, or a distance of the target object.

### TECHNICAL FIELD

Embodiments of the present invention relate generally to remote sensing, and more particularly relate to dynamically grouping detectors to increase signal to noise ratio (SNR) of a light detection and ranging (LiDAR) device.

### BACKGROUND

A LIDAR device can receive noises and signals alike, and the detection range of a LIDAR device is largely determined by the relative intensity of signals and noises (mostly in the form of ambient light), measured by SNR.

Traditional techniques for solid-state LIDAR to increase the angular resolution of the LIDAR device involves shrinking the detector pixel size. However, it often results in shorter detection range due to decreased SNR. The approach to increase the angular resolution without affecting SNR achieve so by sacrificing the total detection angle.

### BRIEF DESCRIPTION OF THE DRAWINGS

Embodiments of the disclosure are illustrated by way of example and not limitation in the figures of the accompanying drawings, in which like references indicate similar elements.

FIG. 1 shows a LiDAR device in one embodiment.

FIG. 2 further illustrates the LiDAR device in one embodiment.

FIGS. 3A-3C illustrate the channel grouping features of the LiDAR device according to an embodiment of the invention.

FIG. 4 illustrates a process of calibrating a LiDAR device so that it can dynamically group an appropriate number of adjacent detector channels according to an embodiment of the invention.

FIG. 5 illustrates a process of using a LiDAR device with the channel grouping feature in real time according to an embodiment of the invention.

FIG. 6 illustrates a process of dynamically grouping detector channels in a LiDAR device according to an embodiment of the invention.

### DETAILED DESCRIPTION

The following description and drawings are illustrative and are not to be construed as limiting. Numerous specific details are described to provide a thorough understanding of various embodiments. However, in certain instances, well-known or conventional details are not described to provide a concise discussion of the embodiments.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

To improve the angular resolution without compromising the detection range, a LiDAR device with detector channel grouping is provided in this disclosure. In an embodiment, the LiDAR device can include a laser pulse scanner configured to scan laser pulses in a plurality of directions; a detector array that includes a plurality of adjacent detector channels; and a controlling unit configured to activate a group of adjacent detector channels of the plurality of adjacent detector channels corresponding to each of the plurality of directions based on one or more of an image width on the detector array corresponding to that direction after a laser pulse hits a target object, a measured ambient intensity from that direction, a reflectivity of the target object, or a distance of the target object.

In an embodiment, the laser pulse scanner is configured to scan the laser pulses vertically or horizontally to project horizontal or vertical illuminated lines onto the target object. Each of the plurality of adjacent detector channels is a column of detectors or a row of detectors. When the group of adjacent detector channels are activated, each of the rest of the plurality of adjacent detector channels are deactivated. The group of detectors includes two or more detector channels. As used herein, activating a detector channel means turning on the detector channel, and deactivating a detector channel means turning off the detector channel.

In an embodiment, the number of adjacent detector channels in the group of adjacent detector channels is determined based on a calibration table selected based on the reflectivity of the target object. The reflectivity of the target object is a Lambertian reflectivity of the target object. In an embodiment, illumination reflected from the target object from the plurality of directions can have the same image width on the detector array. In another embodiment, once the image width corresponding to one scanning direction for each target object range is known, the image width of each other scanning direction can be extrapolated based on the known image width.

Each of the various embodiments described above can be practiced in a method. The above summary does not include an exhaustive list of all embodiments in this disclosure. All apparatuses and methods in this disclosure can be practiced from all suitable combinations of the various aspects and embodiments described in the disclosure.

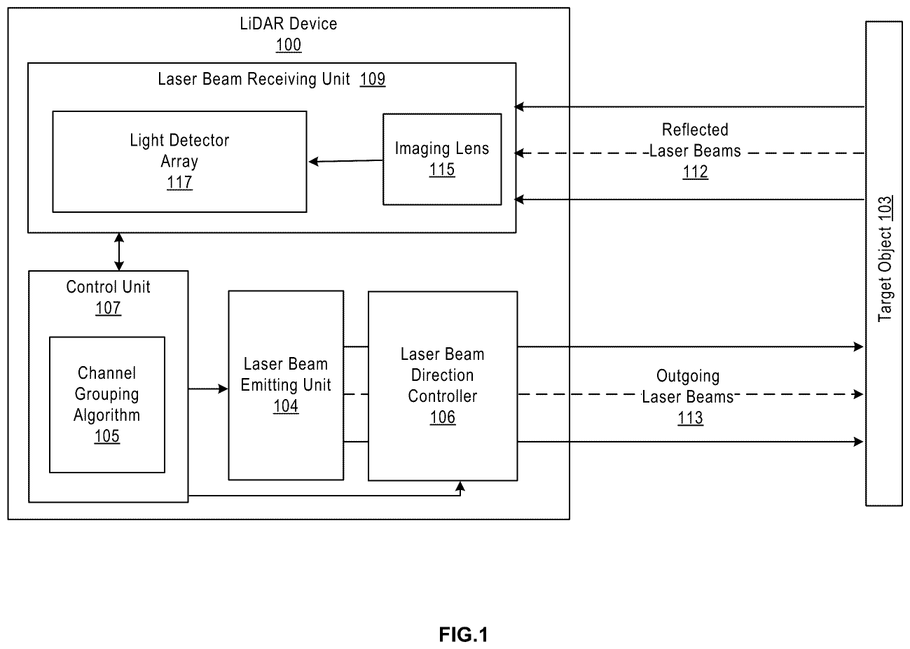

FIG. 1 shows a LiDAR device 100 in one embodiment. The LiDAR device 100 can be a solid-state LiDAR device, which can measure distances to objects in an environment by illuminating the objects with laser beams. Differences in return times of the reflected laser beams and wavelengths can be used to create a point cloud of the environment. The point cloud can provide spatial location and depth information, for use in identifying and tracking objects.

As shown in FIG. 1, the LiDAR device 100 can include a laser beam emitting unit 104, a laser beam direction controller 106, a laser beam receiving unit 109, and a control unit 107. The laser beam emitting unit 104 can include multiple laser emitters, each of which can emit linear laser beams.

Laser beams 113 can be scanned by the laser beam direction controller 106 that can be a MEMS mirror, piezo scanner, a laser array, or another scanning mechanism. Directions of outgoing laser beams 113 can be changed by the shifting device such that the LiDAR device 100 can have denser point clouds along the shifting orientation within the whole predetermined field of view.

The laser beam receiving unit 109 can collect laser beams 112 reflected from a target object 103 using one or more imaging lenses (e.g., imaging lens 115), and focus the reflected laser beams on a detector array 117, which can be a device that includes one or more detectors, each of which can be a high-sensitivity photodiode, for example, a linear mode avalanche-photodiode (APD) or a single-photon avalanche diode (SPAD). The one or more detectors can generate electrons from photons captured by the imaging lens 115 from the reflected laser beams 112. The laser beam receiving unit 109 can send returned signals generated from the one or more detectors to the control unit 107 for processing.

The control unit 107 can include control logic implemented in hardware, software, firmware, or a combination thereof, and can coordinate operations of the laser beam emitting unit 104, the laser beam direction controller 106, and the detector array 117.

For example, the control unit 107 can dynamically turn on and turn off each column of detectors on the detector array 117, depending on which column is to receive reflected pulses. In one embodiment, when a particular column of detectors is turned on, the other columns of detectors on the detector array 117 are turned off.

As further shown, the control unit 107 can include a channel grouping algorithm 105 that can dynamically determine which columns of detectors are to be turned on based on a calibration table created through a calibration process.

By dynamically turning on and turning off the columns of detectors, the SNR of the LiDAR device 100 can be improved, since the turned-off detectors cannot receive any photons, including ambient photons, and since the detectors are turned off, detector noise is also reduced.

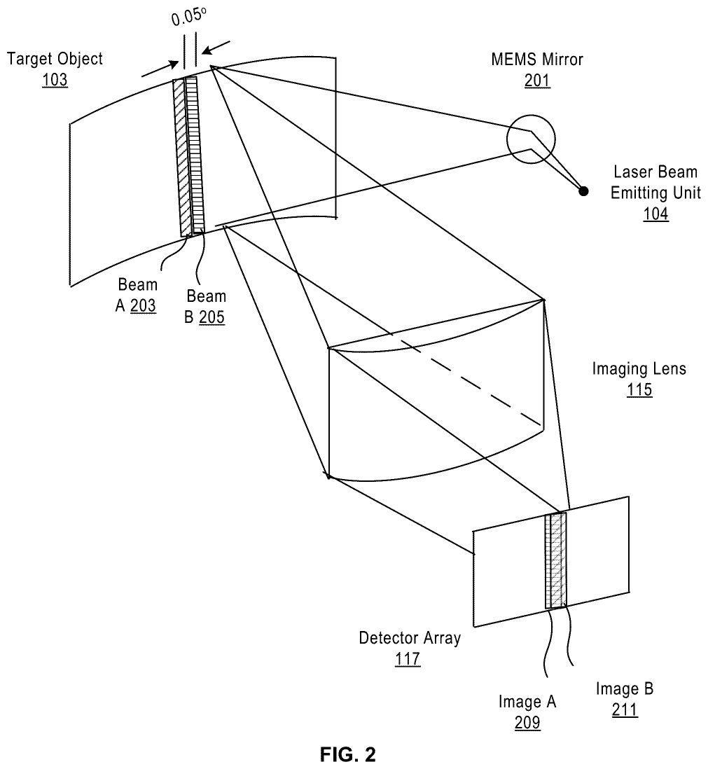

FIG. 2 further illustrates the LiDAR device 100 according to an embodiment of the invention. In this embodiment, the LIDAR device 100 have overlapped images from multiple scanning directions because it does not use the channel grouping feature mentioned above.

As shown above, the laser beam emitting unit 104 can scan linear laser beams horizontally across the target object 103 using a MEMS mirror 201. Each of the scanning laser beams is collimated in the horizontal direction to a particular angle and diverges in the vertical direction to cover the desired field of view. In this embodiment, scanning laser beams 203 and 205 are used for illustration. As shown, each of the laser beams 203 and 205 can be collimated to 0.05 degrees. When the scanning laser beams are reflected from the target object 103 after hitting the target object 103, they pass the imaging lens 115, and form overlapping images 209 and 211 because of various aberrations, such as atmospheric aberrations and focus aberrations. In other words, even if the images 209 and 211 are generated by the detector array 117 from two different non-overlapping scanning beams reflected from the target object 103, they are not clearly separable in the detector array 117.

Some of the existing solutions to the above problem include carving out the overlapping area between the two images 209 and 211 so that only the non-overlapping areas of the two images are processed by the LiDAR device 100. Since the overlapping area that is carved out can be large, the SNR of the LiDAR device is reduced, and so is the detection range of the LiDAR device 100. Another solution is to use smaller detectors with sufficient gaps between the detectors. However, smaller detectors will generally result in lower SNRs, as signals tend to drop quicker than noise. Yet another solution is to use fewer columns of detectors and a larger divergence angle of the scanning laser beams. Fewer columns of detectors means larger detectors, and large detectors tend to receive more ambient noise, resulting in a reduced SNR due to a signal drop and noise increase.

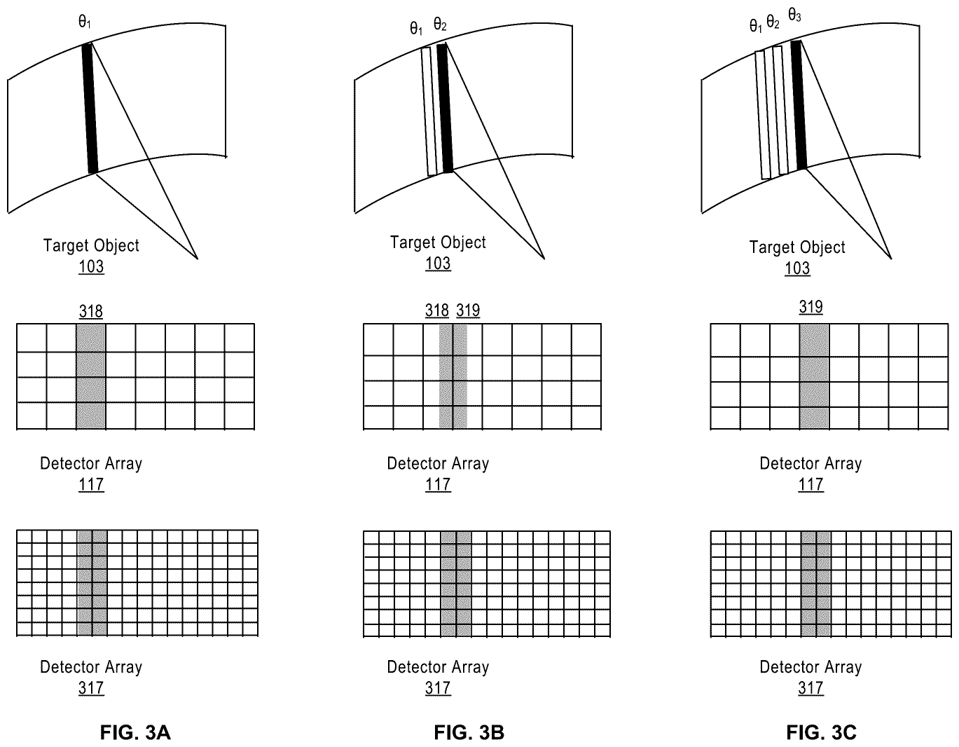

FIGS. 3A-3C illustrate the channel grouping features of the LiDAR device 111 according to an embodiment of the invention.

In each of FIGS. 3A-3C, either the detector array 117 or the detector array 317 can be used in the LiDAR device 100 to receive reflected illuminations from the target object 103. The LiDAR device does not have the channel grouping feature enabled when used with the detector array 117 and has the channel grouping feature enabled when used with the detector array 317.

As shown in FIGS. 3A-3C, each of the detector array 117 and the detector array 317 includes multiple columns of detectors, with each column comprising detectors that are connected by a bus. Each column of detectors is also referred to as a detector channel and can be activated or deactivated in accordance with the channel grouping algorithm 105 in FIG. 1.

However, the detector array 317 includes more columns of detectors, which, in one embodiment, can be twice the detectors in the detector array 117. The columns of detectors in the detector array 317, however, is not limited to that number.

Due to various aberrations and/or detector saturation, it is important to determine the image width of the LiDAR device 100 from a given scanning angle. The reflected illumination typically falls on one or more channels for each of the detector arrays 117 and 317. For example, if at least 90% of the illumination reflected from a particular scanning angle falls on one or more channels, the reflected illumination from that scanning angle is considered as all falling on the one or more channels or as being fully collected by the one or more channels.

In FIGS. 3A-3C, the LiDAR device 100 scans laser pulses horizontally at three different scanning angles (i.e., θ₁, θ₂, and θ₃) sequentially. When the LiDAR device 100 is used with the detector array 117 without the channel group feature enabled, reflected illuminations from some of the scanning angles, e.g., θ₂, may not be fully collected by any single channel.

For example, although, for each of the scanning angles _74 ₁ and θ₃, reflected illumination from the target object 103 is fully collected by one of the activated adjacent detector channels 318 and 319, reflected illumination from the target object 103 is not fully collected by any of the activated detector channels for the scanning angle θ₂, because approximately half of the reflected illumination is lost if only a single channel is activated for that scanning angle. Consequently, the LiDAR device 100 would have a compromised detection range when used with the detector array 117. Although the problem can be resolved using a larger scanning angle in scanning laser such that all reflected illumination from a scanning angle fall on one detector channel, this solution would decrease the angular resolution of the LiDAR device.

According to various embodiments of the invention, the LiDAR device 100 uses the detector array 317 and has the channel grouping feature enabled to improve the detection range and/or the SNR without sacrificing the angular resolution of the LiDAR device 100.

Thus, when the LiDAR device 100 is used with the detector array 317 and with the channel group feature enabled, reflected illuminations from each of scanning angles (i.e., θ₁, θ₂, and θ₃) are fully collected by two activated channels.

In an embodiment, to implement the channel grouping feature on the detector array 317, one or more adjacent detector channels can be activated to approximately match the image width on the detector array such that the reflected illumination from any scanning angle is fully collected by the activated detector channels.

In FIGS. 3A-3B, two adjacent detector channels are activated simultaneously corresponding to each scanning angle. In one embodiment, the signals falling on each detector in the two adjacent channels can be added in either an analog manner (e.g., summing amplifier) or digitally (e.g., multi-level adder). Although two adjacent detector channels are used here, the implementation is not limited to two adjacent detector channels nor limited to adjacent detector channels.

In one embodiment, the LiDAR device 100 can dynamically activate multiple adjacent detector channels based on a variety of factors, which include both the optical properties of the LiDAR device 100 and some external factors. The optical properties of the LiDAR device includes the width of the detector in each detector channel, the angular resolution of the detector array 317, the laser illumination divergence angle, and the image width on the detector array 317. The image width is primarily determined by external factors, such as the distance of the target object, the ambient intensity, and the Lambertian reflectivity of the target object.

Table 1 below illustrates examples of the optical properties of the LiDAR device 100 according to an embodiment of the invention.

TABLE 1

| Parameter | Parameter Values | | | | |
|---|---|---|---|---|---|
| Focal length of imaging lens | 10 | | mm | | |
| | Case 1 | | | Case 2 | |
| SPAD pixel size | 10 | um | | 20 | um |
| Receiver angular resolution | 0.06 | deg | | 0.12 | deg |

| | | |
|---|---|---|
| Laser Illumination Divergence | 0.05 | deg |
| Received Beam Size | 20 | um |

As shown in the table 1 above, the LiDAR device 100 has an imaging lens with a focal length of 10 mm and a received beam size of 20 μm for the target object 103 that is positioned at a particular distance from the LiDAR device 100. The first set of parameter values (i.e., 20 μm and 0.12 degrees) corresponding to case 1 is for the detector array 317, while the second set of parameter values (i.e., 10 μm and 0.06 degrees) corresponding to case 2 is for the detector array 117. Thus, each detector channel in the detector array 117 is twice the width of each detector channel in the detector array 317. Consequently, the angular resolution of the LiDAR device 100 in case 1 is twice that of the LiDAR device 100 in case 2. As used herein, the angular resolution describes the ability of the LiDAR device 100 to distinguish small details of an object. Thus, the smaller the scanning angle, the higher the angular resolution.

In an embodiment, custom angular resolution can also be achieved when an appropriate number of adjacent detector channels are activated as a group corresponding to each scanning angle. The width of a single channel defines the smallest angular resolution that the LiDAR device 100 can achieve without compromising the detection range (or SNR) of the LiDAR device 100.

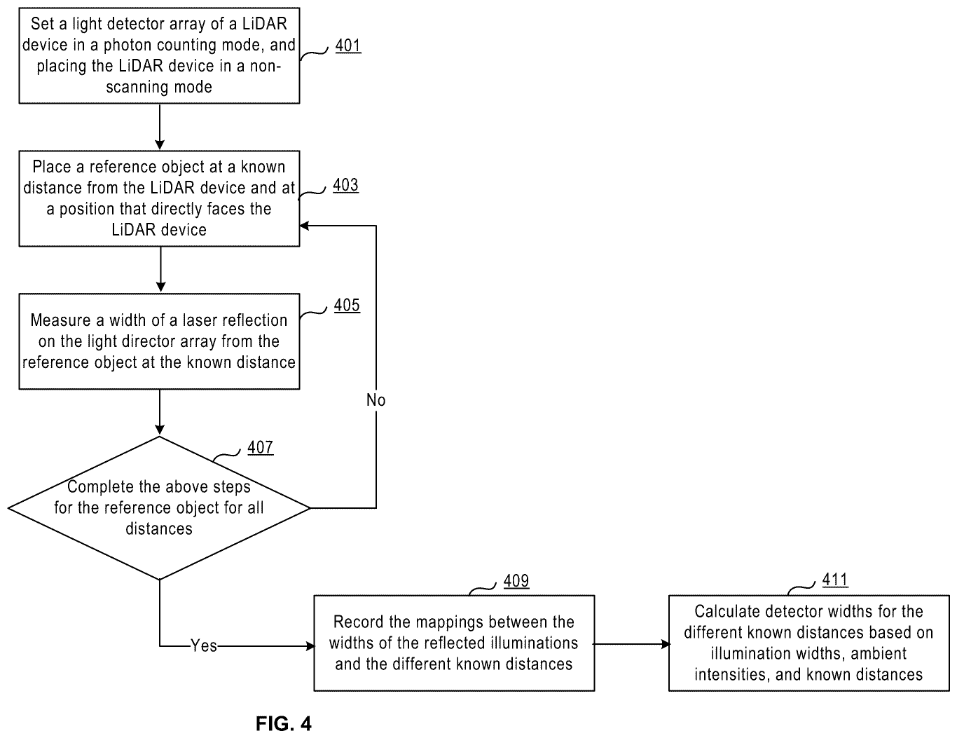

FIG. 4 illustrates a process of calibrating a LiDAR device so that it can dynamically group an appropriate number of adjacent detector channels according to an embodiment of the invention.

The process can be performed after the LiDAR device is assembled and before it is put into operation and can be performed for different reference objects with different Lambertian reflectivities (e.g., 10%, 20%, 30%, 40%, . . . 90% and 100%). The purpose of the process is to create a calibration table for each of the reference objects based on the optical properties of a design of the LiDAR device.

At step 401, the detector array of the LiDAR device is set to a photon counting mode, and the LiDAR device is set to a non-scanning mode.

At step 402, the reference object with one of the Lambertian reflectivities is placed at a position (e.g., 1 m from the LiDAR device) directly facing the LiDAR device such that laser beam emitted from the LiDAR device would be at a horizontal scanning angle of 0 degree. This step can be performed at the same time or before step 401.

At step 405, the image width from the reference object is measured on the detector array. Ambient intensity can also be measured at this step.

At step 407, steps 403 and 405 can be repeated for each of a plurality of range distances of the LiDAR devices. Each of the predetermined positions is directly in front of the LiDAR device. For example, the reference object can be placed at positions that are 0.2 m, 0.5 m, 0.8 m, 1 m, 2 m, 5 m, 10 m, 20 m, 50 m, 100 m, and 250 m away from the LiDAR device.

At step 409, after the image widths on the detector array from the reference object at the different distances are measured, the LiDAR device can record the mappings between the image widths and the distances.

At 411, based on the measured ambient intensity and the recorded image widths from the reference object with the reflectivity at the different known distances, a corresponding detector width that needs to be activated from each known distance can be calculated.

In an embodiment, when calculating the detector width, multiple factors, such as the image width corresponding to the known distance, the ambient intensity, and the distance itself, can be considered.

Ambient intensity is a major source of noise that can impact the SNR of the LiDAR device. Although a larger group of detector channels grouped together and activated may receive more signals, it can also receive more ambient light as noise. Thus, ambient intensity can impact the detector width for a known distance. Further, the distance of the reference target itself can also impact the detector width due to the biostatic nature of the LiDAR device, where the laser emitter and the receiver (i.e., the detector array) are at different locations.

Once the detector width is determined for each distance, the number of adjacent detector channels need to be grouped together and activated to match the width of the reflected illumination for the distance can determined because the width of each detector channel is known. In one embodiment, the adjacent detector channels grouped together needs to be collected at least 90% of photos in the reflected illumination.

In an embodiment, after the LiDAR device 100 is calibrated using the process above, the LiDAR device 100 can include multiple calibration tables, each calibration table for one of the reference objects with different Lambertian reflectivities. Each calibration table can include multiple entries. Each entry include at least a reference distance, an ambient light intensity, an image width, and a corresponding detector width. An example of such a calibration table for a reference object with a Lambertian reflectivity of 10% is provided below.

TABLE 2

| | | | Ambient | | Image | Detector Width for |
|---|---|---|---|---|---|---|
| Distance | | Reflectivity | Intensity | | Width | the highest SNR |
| 0.2 | m | 10% | 100 | klux | 64 um | 56 um |
| 0.2 | m | 10% | 10 | klux | 64 um | 60 um |
| 0.2 | m | 10% | 1 | klux | 64 um | 64 um |
| 0.2 | m | 50% | 100 | klux | 64 um | 58 um |
| 0.2 | m | 50% | 10 | klux | 64 um | 61 um |
| 0.2 | m | 50% | 1 | klux | 64 um | 64 um |
| 0.2 | m | 80% | 100 | klux | 64 um | 60 um |
| 0.2 | m | 80% | 10 | klux | 64 um | 62 um |
| 0.2 | m | 80% | 1 | klux | 64 um | 64 um |
| 2 | m | 10% | 100 | klux | 58 um | 50 um |
| 2 | m | 10% | 10 | klux | 58 um | 54 um |
| 2 | m | 10% | 1 | klux | 58 um | 58 um |
| 2 | m | 50% | 100 | klux | 58 um | 52 um |
| 2 | m | 50% | 10 | klux | 58 um | 56 um |
| 2 | m | 50% | 1 | klux | 58 um | 58 um |
| 2 | m | 80% | 100 | klux | 58 um | 53 um |
| 2 | m | 80% | 10 | klux | 58 um | 56 um |
| 2 | m | 80% | 1 | klux | 58 um | 58 um |
| 20 | m | 10% | 100 | klux | 32 um | 20 um |
| 20 | m | 10% | 10 | klux | 32 um | 25 um |
| 20 | m | 10% | 1 | klux | 32 um | 30 um |
| 20 | m | 50% | 100 | klux | 32 um | 25 um |
| 20 | m | 50% | 10 | klux | 32 um | 28 um |
| 20 | m | 50% | 1 | klux | 32 um | 32 um |
| 20 | m | 80% | 100 | klux | 32 um | 27 um |
| 20 | m | 80% | 10 | klux | 32 um | 30 um |
| 20 | m | 80% | 1 | klux | 32 um | 32 um |
| 200 | m | 80% | 100 | klux | 24 um | 15 um |
| 200 | m | 80% | 10 | klux | 24 um | 18 um |
| 200 | m | 80% | 1 | klux | 24 um | 22 um |

As shown above, the detector width can be determined by a combination of the distance of the reference object, the ambient intensity, and the image width.

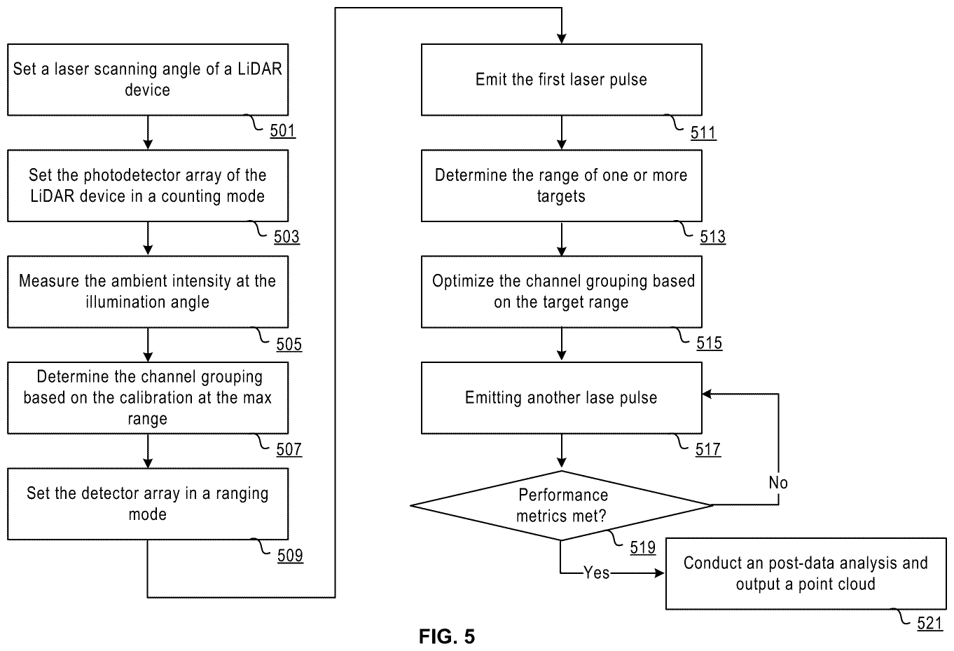

FIG. 5 illustrates a process of using a LiDAR device with the channel grouping feature in real time according to an embodiment of the invention. After a LiDAR device is calibrated using the process illustrated in FIG. 4, the LiDAR device can be put into operation. For example, the LiDAR device can be installed on an autonomous driving vehicle.

At step 501, the LiDAR device sets a laser scanning angle. This scanning angle can be one of multiple horizontal scanning angles when the LiDAR is in operation.

At step 503, the detector array of the LiDAR device is set to a photon counting mode, in which the detector array of the LiDAR device is focused on counting the number of ambient photons that are reflected back to the LiDAR device.

At step 505, the LiDAR device measures the ambient intensity at the laser scanning angle. The ambient intensity refers to the ambient light intensity at the laser scanning angle and can be measured in the photon counting mode.

At step 507, the LiDAR device determines an initial detector width based on the max detection range of the LiDAR device, a default image width, and the measured ambient intensity according to a calibration table. In an embodiment, the calibration table initially used can be any of the calibration tables created using the process in FIG. 4. In an embodiment, the max distance is part of the specifications of the LiDAR device.

At step 509, once the number of adjacent detector channels that needs to be turned on as a group initially is determined, the detector array of the LiDAR device is set to a ranging mode.

At step 511, the LiDAR device emits a first laser pulse in the laser scanning direction. In an embedment, the LiDAR device is configured to emit multiple laser pulses in each laser scanning direction.

At step 513, the LiDAR device determines the distance of each of one or more targe objects in the laser scanning direction based on the measured time that it takes for the first laser pulse to travel to each targe object and return to the detector array. Photons of the first laser pulse can be received by the adjacent detector channels that are turned on at step 507. The Lambertian reflectivity of each of the one or more target objects is also measured based at least on the number of reflected photons received.

At step 515, the number of adjacent detector channels that turned on as a group at step 507 can be optimized based on one or more of the distance of the target object that is the farthest from the LiDAR device, the measured ambient intensity at step 505, and the image width of the farthest target object on the detector array and according to a calibration table, which can be selected from a number of calibration tables created using the process in FIG. 4 according to the Lambertian reflectivity measured at step 513.

In an embodiment, the calibration table selected for the farthest target object can be one of the calibration tables that is created for a reference object with a Lambertian reflectivity that is the closest to the measured Lambertian reflectivity of the furthest target object.

For example, if the measured Lambertian reflectivity is 18%, then the calibration table for the reference object with a Lambertian reflectivity of 20% would be selected. If the measured Lambertian reflectivity is 13%, then the calibration table for the reference object with a Lambertian reflectivity of 10% would be selected.

At step 517, the LiDAR device emits a second laser pulse in the laser scanning direction, and reflected laser pulse of the second laser pulse is received by the group of adjacent detector channels that are turned on at step 515.

At step 519, the LiDAR device determines if a performance metric has been met. If not, step 517 can be repeated until the LIDAR device's performance metric or the confidence level is reached, but the number of repetitions will be capped at a predetermined limit. If yes, the LiDAR device can conduct an analysis of received photons on the adjacent detector channels turned on as a group as determined at step 515, and outputs a point cloud.

In one embodiment, the performance metric is not a fixed performance metric but rather is dynamically determined. An example algorithm for determining the performance metric can be described as follows: if a range value is repeated at least three times with a difference +/−2 cm, then a performance metric is determined to be met and the LiDAR device can move on to the next scanning angle.

As an illustrative example, a LiDAR device is configured to emit 4 (the limit on the number of laser pulses) laser pulses at each scanning angle, and the detected ranges of the target object from the 4 laser pulses are as follows: Laser Pulse #1, 10.24 m; Laser Pulse #2, 10.23 m; Laser Pulse #3, 9.10 m; Laser Pulse, 10.25 m.

In the above example, a range value (i.e., (10.24 m+10.23 m+10.25 m)/3=10.24 m) is repeated three times (i.e., 10.24 m, 10.23 m, and 10.25 m), with a difference of +/−2 cm. Therefore, the detected range 10.24 m is the performance metric. If such a performance metric is met at the end of the 3^{rd} laser pulse, the LiDAR device will not emit the 4^{th} laser pulse. However, if no performance metric is met at the end of the 4 lase pulse, the LiDAR device will use the average value of the 4 detected ranges as the detected range at the scanning angle and move to the next scanning angle.

The LiDAR device can repeat the above steps 501-519 for each laser scanning direction.

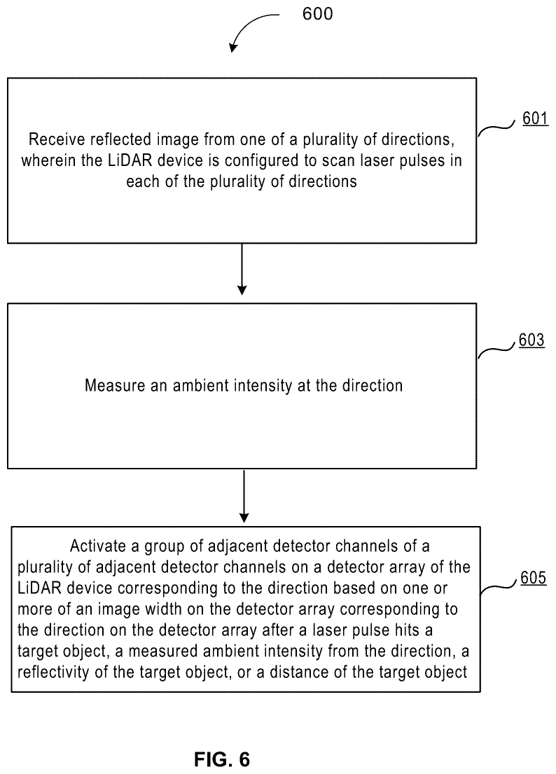

FIG. 6 illustrates a process 600 of dynamically grouping detector channels in a LiDAR device according to an embodiment of the invention.

At step 601, the LiDAR device receives reflected image from one of a plurality of directions, wherein the LiDAR device is configured to scan laser pulses in each of the plurality of directions.

At step 603, the LiDAR device measures an ambient intensity in the direction.

At step 605, the LiDAR device activates a group of adjacent detector channels of a plurality of adjacent detector channels on a detector array of the LiDAR device corresponding to the direction based on one or more of an image width from the direction on the detector array after a laser pulse hits a target object, a measured ambient intensity from the direction, a reflectivity of the target object, or a distance of the target object.

Some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

All of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

Where a phrase similar to “at least one of A, B, or C,” “at least one of A, B, and C,” “one or more A, B, or C,” or “one or more of A, B, and C” is used, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

In construing the claims of this document, the inventor(s) invoke 35 U.S.C. § 112(f) only when the words “means for” or “steps for” are expressly used in the claims. Accordingly, if these words are not used in a claim, then that claim is not intended to be construed by the inventor(s) in accordance with 35 U.S.C. § 112(f).

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A light detection and ranging (LiDAR) device, comprising:
a laser pulse scanner configured to scan laser pulses in a plurality of directions;
a detector array that includes a plurality of adjacent detector channels; and
a controlling unit configured to activate a group of adjacent detector channels of the plurality of adjacent detector channels corresponding to each of the plurality of directions based on one or more of an image width on the detector array corresponding to that direction after a laser pulse hits a target object, a measured ambient intensity from that direction, a reflectivity of the target object, or a distance of the target object.

2. The LiDAR device of claim 1, wherein laser pulse scanner is configured to scan the laser pulses vertically or horizontally to project horizontal or vertical illuminated lines onto the target object.

3. The LiDAR device of claim 1, wherein each of the plurality of adjacent detector channels is a column of detectors or a row of detectors.

4. The LiDAR device of claim 1, wherein when the group of adjacent detector channels are activated, each of the rest of the plurality of adjacent detector channels are deactivated.

5. The LiDAR device of claim 1, wherein the group of detectors includes two or more detector channels.

6. The LiDAR device of claim 1, wherein the number of adjacent detector channels in the group of adjacent detector channels is determined based on a calibration table selected based on the reflectivity of the target object.

7. The LiDAR device of claim 6, wherein the reflectivity of the target object is a Lambertian reflectivity of the target object.

8. The LiDAR device of claim 1, wherein the image width corresponding to each of the plurality of directions on the detector array after a laser pulse hits the target object is approximately the same.

9. A method applied to a light detection and ranging (LiDAR) device, comprising:
receiving reflected illumination from one of a plurality of directions, wherein the LiDAR device is configured to scan laser pulses in each of the plurality of directions;
measuring an ambient intensity in the direction; and
activating a group of adjacent detector channels of the plurality of adjacent detector channels corresponding to each of the plurality of directions based on one or more of an image width on the detector array corresponding to that direction after a laser pulse hits a target object, a measured ambient intensity from that direction, a reflectivity of the target object, or a distance of the target object.

10. The method of claim 9, wherein laser pulse scanner is configured to scan the laser pulses vertically or horizontally to project horizontal or vertical illuminated lines onto the target object.

11. The method of claim 9, wherein each of the plurality of adjacent detector channels is a column of detectors or a row of detectors.

12. The method of claim 9, wherein when the group of adjacent detector channels are activated, each of the rest of the plurality of adjacent detector channels are deactivated.

13. The method of claim 9, wherein the group of detectors includes two or more detector channels.

14. The method of claim 9, wherein the number of adjacent detector channels in the group of adjacent detector channels is determined based on a calibration table selected based on the reflectivity of the target object.

15. The method of claim 14, wherein the reflectivity of the target object is a Lambertian reflectivity of the target object.

16. The method of claim 9, wherein the image width corresponding to each of the plurality of directions on the detector array after a laser pulse hits the target object is the same.

17. A circuit embedded in a light detection and ranging (LiDAR) device, wherein the circuit is configured to cause the LiDAR device to perform operations comprising:
receiving reflected illumination from one of a plurality of directions, wherein the LiDAR device is configured to scan laser pulses in each of the plurality of directions;
measuring an ambient intensity in the direction; and
activating a group of adjacent detector channels of the plurality of adjacent detector channels corresponding to each of the plurality of directions based on one or more of an image width on the detector array corresponding to that direction after a laser pulse hits a target object, a measured ambient intensity from that direction, a reflectivity of the target object, or a distance of the target object.

18. The circuit of claim 17, wherein laser pulse scanner is configured to scan the laser pulses vertically or horizontally to project horizontal or vertical illuminated lines onto the target object.

19. The circuit of claim 17, wherein each of the plurality of adjacent detector channels is a column of detectors or a row of detectors.

20. The circuit of claim 17, wherein when the group of adjacent detector channels are activated, each of the rest of the plurality of adjacent detector channels are deactivated.
